(19) United States
(12) Patent Application Publication
(10) Pub. No.: US 2014/0278863 A1
(43) Pub. Date: Sep. 18, 2014

(54) SYSTEMS, METHODS AND APPARATUS FOR PROVIDING UNIQUELY TRACK ABLE ITEMS WHICH PROVIDES ADDITIONAL REVENUE STREAMS AND BENEFITS FOR RETAILERS AND AFFILIATES

(71) Applicant: Foo Katan, Beverly Hills, CA (US)

(72) Inventor: Foo Katan, Beverly Hills, CA (US)

(21) Appl. No.: 13/843,013

(22) Filed: Mar. 15, 2013

(51) Int. Cl. G06Q 30/02

(52) U.S. Cl. CPC G06Q 30/0214; G06Q 30/0255
USPC 705/14.16

(57) ABSTRACT

The method of the present disclosure comprises providing an item containing a unique identifier to seller of the item where the unique identifier identifies at least the location and purchaser or user of the item, receiving information about at least the location and use of the item from the purchaser or user of the item, providing the purchaser or user of the item with one or more offers or incentives that are specifically tailored to the individual purchaser or user based on the location and use information received from the purchaser or user of the item and providing the seller with a monetary incentive or reward whenever the seller sells the item or the purchaser or user accepts one or more offers or incentives that are specifically tailored to the individual purchaser or user based on the location and use information received from the purchaser or user of the item.

### BACKGROUND OF THE INVENTION

1. Field of the Disclosure

The present disclosure relates generally to systems, methods and apparatus for providing a uniquely trackable item for sale to one or more retailers or affiliates. More specifically, the present disclosure relates to providing a uniquely trackable item that can be tracked throughout its entire lifecycle and provides the retailer and affiliates various benefits and advantages.

2. General Background

Generally the retailer or seller for any item does not have an incentive of selling any particular item over the other items in his store since he does not benefit from it. The present disclosure provides an item which can be tracked and the retailer and affiliates of the item gains monetary profit and various other benefits and advantages. Thus the retailer and affiliate for the item are motivated to sell a particular item over other items in the store.

Employing such means would also enhance the product placement of the particular item in the stores as the retailers would try to sell that item over others since they receive a percentage of the online revenue generated. The system and method for providing a trackable item encourages the customer to buy the item and monetize the online world.

There exists a need to provide an item which is trackable, by ID tagging or any other known or later developed means of tracking, which provides monetary gains and other benefits to the retailer and affiliate.

There exists a need for the retailer and affiliate of the item to understand the use of the item by the consumer and provide customized offers and marketing strategies for the user based on the user's activity, location and use of the item.

There also exists a need for the retailer and affiliate of the item to deepen and improve the relationship between it and the consumer/user of the item and capitalize on opportunities to encourage additional/related purchases by the same consumer/user.

There also exists a need to provide a trackable item which can be tracked by the provider or retailer providing information about the location, use of and user of the item based on which future marketing strategies can be decided.

There also exists a need to establish an ongoing relationship between the retailer and the purchaser/user of the item.

There also exists need to be able to identify and track each and every individual item and its accessories that further personalizes the experience.

The benefit in offering consumers such an item not only increases the consumer's usage, but also increases the retailer's potential marketing opportunities and revenue sources.

Additionally, there exists a need for an item that is uniquely identifiable and personalized to the owner/user of the item. The present disclosure provides these and other related benefits and advantages.

### SUMMARY

The present disclosure is directed to a system, method and apparatus for providing a trackable item for sale to one or more retailers or affiliates. The uniquely trackable items are tagged or otherwise made trackable, which allows the item to be tracked throughout its entire lifecycle and provide various benefits and advantages to retailer and affiliates.

One aspect of the present disclosure, the methods and systems are referred to as the Retail Affiliate Model™ or RAM.

In an embodiment of the present disclosure, a system, method and apparatus for providing a trackable item, the method comprising: (1) providing an item containing a unique identifier to seller of the item where the unique identifier identifies at least the location and purchaser or user of the item; (2) receiving information about at least the location and use of the item from the purchaser or user of the item; (3) providing the purchaser or user of the item with one or more offers or incentives that are specifically tailored to the individual purchaser or user based on the location and use information received from the purchaser or user of the item and (4) providing the seller with a monetary incentive or reward whenever the seller sells the item or the purchaser or user accepts one or more offers or incentives that are specifically tailored to the individual purchaser or user based on the location and use information received from the purchaser or user of the item.

In one aspect of at least one embodiment of the present disclosure, the information about at least the location and use of the item from the purchaser or user of the item is transmitted from the purchaser or user through computer, a mobile device or device having internet connectivity.

In one aspect of at least one embodiment of the present disclosure, a system, method and apparatus for providing a trackable item wherein the retailer and affiliate gain a percentage of the revenue generated each time they sell the item.

In one aspect of at least one embodiment of the present disclosure, the offers or incentives is the ability to participate in an interactive on-line community that incorporates a digital version of the item

In another aspect of at least one embodiment of the present disclosure, a system, method and apparatus for providing a trackable item wherein the retailer and affiliate gain benefits and advantages each item the user buys accessories or related items for the trackable item.

In yet another aspect of at least one embodiment of the present disclosure, a system, method and apparatus for providing a trackable item wherein the unique identifier of the trackable item is a radio frequency identifier.

In yet another aspect of at least one embodiment of the present disclosure, a system, method and apparatus for providing a trackable item wherein the provider of the item gains a percentage of the revenue generated from the sale of each item.

In yet another aspect of at least one embodiment of the present disclosure, a system, method and apparatus for providing a trackable item wherein the uniquely trackable item can be tracked throughout its lifecycle.

In yet another aspect of at least one embodiment of the present disclosure, a system, method and apparatus for providing a trackable item wherein the user registers the item online allowing the item to be tracked.

In yet another aspect of at least one embodiment of the present disclosure, a system, method and apparatus for providing a trackable item wherein the unique identifier of the item interacts with a computer, a mobile device or device having internet connectivity and provides information regarding at least the location, use of and user of the item by one or more users.

In yet another aspect of at least one embodiment of the present disclosure, the seller will receive additional award or incentive for selling the most number of the item or generating the most profit or revenue from the purchaser or user accepting offers or incentives that are specifically tailored to the individual purchaser or user based on the location and use information received from the purchaser or user of the item.

In yet another embodiment of the present disclosure, a system, method and apparatus for providing a trackable item that works on a business model by sharing future online revenue with channel partners in retail and/or distribution. In yet another embodiment of the present disclosure, the seller uses the information to modify the design, distribution channel, or location of the item

In yet another embodiment of the present disclosure, a system, method and apparatus for providing a trackable item wherein each item is given a unique ID tag in the factory before it is shipped out which is registered in the back office by the provider.

In yet another aspect of at least one embodiment of the present disclosure, a system, method and apparatus for providing a trackable item wherein the unique item ID is linked to the final retail destination at distribution.

In yet another aspect of at least one embodiment of the present disclosure, a system, method and apparatus for providing a trackable item wherein the one or more users connect online and register the item online using the unique ID tag which facilitates tracking of that particular item and activity of the one or more users with that item.

In yet another aspect of at least one embodiment of the present disclosure, a system, method and apparatus for providing a trackable item wherein all future revenue is tracked, communicated and shared.

In yet another aspect of at least one embodiment of the present disclosure, a system, method and apparatus for providing a trackable item wherein the trackable item can be tracked online throughout its entire lifecycle.

In yet another aspect of at least one embodiment of the present disclosure of a system, method and apparatus for a trackable item wherein each item is tracked right from the factory, through the channel of distribution to the consumer.

In yet another aspect of at least one embodiment of the present disclosure, a system, method and apparatus for providing a trackable item providing the retailer/affiliate of an item to receive a percentage of the online revenue generated.

In yet another aspect of at least one embodiment of the present disclosure a system, method and apparatus for providing a trackable item a system, method and apparatus for providing a trackable item that encourages the retailer/affiliate to sell more of the trackable items to the users as they benefit each time they make the sale.

In yet another aspect of at least one embodiment of the present disclosure, a system, method and apparatus for providing a trackable item wherein the shelf space of the trackable item is enhanced in the store since the retailers have an incentive to sell the trackable items over other items in the store as he receives a percentage share of the revenue.

In yet another aspect of at least one embodiment of the present disclosure, a system, method and apparatus for a providing a trackable item which motivates in store promotion of the trackable item over other items present in the store as the retailer has an incentive to sell the trackable item over other items.

In yet another aspect of at least one embodiment of the present disclosure, a system, method and apparatus for providing a trackable item that can be used as a new channel acquisition tool.

In yet another aspect of at least one embodiment of the present disclosure is a system, method and apparatus for providing a trackable item wherein the retailer of the item receives a percentage of the revenue generated by the sale of the item and related products.

In yet another aspect of at least one embodiment of the present disclosure, a system, method and apparatus for providing a trackable item wherein the retailer receives a percentage share of the revenue when the user is in the store to buy the uniquely trackable item or related products for the uniquely trackable item and ends up buying other products from the store.

In yet another aspect of at least one embodiment of the present disclosure, a system, method and apparatus for providing a trackable item that improves the relationship between the retailer and user of the trackable item and capitalizes on opportunities to encourage additional/related purchases by the same user.

In yet another aspect of at least one embodiment of the present disclosure, a system, method and apparatus for providing a trackable item wherein the unique identifier of the trackable item interacts with at least a computer, a mobile device or device having internet connectivity and provides information regarding at least the location, use of or user of the item by the one or more users of the trackable item.

In yet another aspect of at least one embodiment of the present disclosure, a system, method and apparatus for providing a trackable item wherein the unique identifier tag of the trackable item is a radio frequency identifier (RFID).

In yet another embodiment of the present disclosure, a system, method and apparatus for providing a trackable item further comprising an interactive device which connects the uniquely trackable item to its digital version. In yet another aspect of the present disclosure, a system, method and apparatus for providing a trackable item wherein the physical item gets associated to the digital world by scanning the unique identifier of the trackable item onto the interactive device.

In yet another aspect of at least one embodiment of the present disclosure, a system, method and apparatus for providing a trackable item wherein the user registers the trackable item by scanning the unique identifier and wherein the trackable item can be tracked in its entire lifecycle.

In yet another aspect of at least one embodiment of the present disclosure, a system, method and apparatus for providing a trackable item wherein the user registers the trackable item online allowing the trackable item to be tracked by the retailer/affiliate.

In yet another aspect of at least one embodiment of the present disclosure, a system, method and apparatus for providing a trackable item wherein the retailer/affiliate can track the usage of the trackable item by the user and can offer sale/promotions based on the activity of the user making it a more personalized experience for both the user and the retailer encouraging more sale.

In yet another embodiment of the present disclosure, a system, method and apparatus for providing a trackable item which aids retail and distribution in inventory allocation of the items. In yet another aspect of at least one embodiment of the present disclosure, a system, method and apparatus for providing a trackable item wherein the allocation of the inventory is done based on the popularity of the items in those geographical and demographic areas.

In yet another embodiment of the present disclosure, providing motivation to one or more entities involved in the retail distribution chain including and not limited to distributors, promoters, products owners etc.

In yet another embodiment of the present disclosure, providing marketing benefits by giving out promotions and offers to encourage users to come back to the retailers or other physical locations. In yet another aspect of at least one embodiment of the present disclosure, providing digital and physical give away to generate traffic back to the retailer or other promotion partners including but not limited to museums, stores, venues, famous locations etc.

In yet another embodiment of the present disclosure, a system, method and apparatus for providing a trackable item wherein each user is provided with a unique ID card. In yet another aspect of at least one embodiment of the present disclosure wherein the unique ID card stores the information and data about the items and related items already purchased by the user without the user having to physically carry all the items. In yet another aspect of at least one embodiment of the present disclosure wherein the user can log into his account using the unique ID card and view his collection of items. In yet another aspect of at least one embodiment of the present disclosure, if the user goes to any retail store to buy the item or related items, the user can use the unique ID card which recognizes the items the user has already purchased and can buy related items and accessories accordingly. In yet another aspect of at least one embodiment of the present disclosure, wherein the user gets free gifts on selected days if the user takes and shows the toy or the ID card at the store or via geo tag confirmation from the mobile device.

In yet another embodiment of the present disclosure, a system, method and apparatus for providing a trackable item wherein if the user is in the store to buy the uniquely trackable ID tagged item and ends up buying other unrelated items from the store, the retailer or affiliate provide a percentage share of the revenue generated back to the provider of the uniquely trackable ID tagged item.

In yet another embodiment of the present disclosure, a system, method and apparatus for providing a trackable item that encourages product tagging. In yet another aspect of at least one embodiment of the present disclosure, wherein if the user takes a picture of the bar code of one or more specific products the user gets incentives and prizes and special downloads. In yet another aspect of at least one embodiment of the present disclosure wherein the promotional offers, incentives and prizes to the user are limited to a specific time. In yet another aspect of at least one embodiment of the present disclosure wherein the product tagging is done using one or more digital devices including but not limited to a cellphone or a tablet. In yet another aspect of at least one embodiment of the present disclosure, wherein users participate in adventure activities and compete with other users to earn incentives and free gifts. For example and not by way of limitation users can be asked to perform various a task in a specific time and based on the performance of the user they are provided with free gifts and incentives. In yet another aspect of at least one embodiment of the present disclosure, wherein incentives and free gifts are provided to retailers and product partners.

In yet another embodiment of the present disclosure, wherein the user can download a digital version of the item first. In yet another aspect of at least one embodiment of the present disclosure, once the user has downloaded the digital version of the item, a fulfillment partner will send the physical item to the user and then the digital version of the item is connected to the physically tagged item. In yet another aspect of at least one embodiment of the present disclosure wherein the physical item and the digital world are associated when the user puts and scans the item on the interactive device.

In yet another embodiment of the present disclosure wherein the fulfillment system can be customized and automated which allows identifying the associated ID tag number of the item at fulfillment.

For purposes of the present disclosure, the term item shall include, but not be limited to, any saleable product or service.

It should be appreciated that the present disclosure can reside on an application on a mobile device as well as online on a virtual server. It should also be appreciated that the present disclosure works with or without connectivity to the internet. It should be appreciated that the present disclosure provides, among other things, various advantages and benefits to retailer/affiliate who sell the uniquely trackable items. Also, the user's interaction with the uniquely trackable item and other related items can be tracked and based on it user can be provided with specific promotions and advertisements.

### BRIEF DESCRIPTION OF THE DRAWINGS

The above-mentioned features and objects of the present disclosure will become more apparent with reference to the following description taken in conjunction with the accompanying drawings wherein:

FIG. 1 shows the block diagram of one embodiment of the system, method and apparatus for providing the uniquely trackable items which provide additional revenue streams and benefits for retailers and affiliates.

FIG. 2 shows the block diagram of another embodiment of the system, method and apparatus for providing the uniquely trackable items which provide additional revenue streams and benefits for retailers and affiliates.

FIG. 3 shows the block diagram of another embodiment of the system, method and apparatus for providing the uniquely trackable items which provide additional revenue streams and benefits for retailers and affiliates.

FIG. 4 shows the block diagram of another embodiment of the system, method and apparatus for providing the uniquely trackable items which provide additional revenue streams and benefits for retailers and affiliates.

FIG. 5 shows the block diagram of yet another embodiment of the system, method and apparatus for providing the uniquely trackable items which has a unique radio frequency identifier.

FIG. 6 shows the block diagram of yet another embodiment of the system, method and apparatus for providing the uniquely trackable items where the user registers the item online allowing the item to be tracked.

FIG. 7 shows the block diagram of yet another embodiment of the system, method and apparatus for providing the uniquely trackable items where the uniquely trackable item can be tracked throughout its lifecycle.

FIG. 8 shows the block diagram of yet another embodiment of the system, method and apparatus for providing the uniquely trackable items where the unique identifier of the item interacts with a computer, a mobile device or device having internet connectivity and provides information regarding at least the location, use of and user of the item by one or more users.

FIG. 9 shows the block diagram of yet another embodiment of the system, method and apparatus for providing the uniquely trackable items where customized offers and marketing strategies is provided for each user based on at least the location, use of and user of the item.

### DETAILED DESCRIPTION

The present disclosure is directed to a system, method and apparatus for providing a trackable item for sale to one or more retailers or affiliates. The uniquely trackable items are ID tagged which allows the item to be tracked throughout its entire lifecycle and provide various benefits and advantages to retailer or affiliates.

FIG. 1 shows in accordance with at least one embodiment of the present disclosure, a method for providing the uniquely trackable items which provide additional revenue streams and benefits for retailers and affiliates. In one embodiment of the present disclosure, the method for providing a uniquely trackable item for sale to one or more retailer or affiliates comprises providing an item containing a unique identifier to seller of the item where the unique identifier identifies at least the location and purchaser or user of the item; receiving information about at least the location and use of the item from the purchaser or user of the item; providing the purchaser or user of the item with one or more offers or incentives that are specifically tailored to the individual purchaser or user based on the location and use information received from the purchaser or user of the item and providing the seller with a monetary incentive or reward whenever the seller sells the item or the purchaser or user accepts one or more offers or incentives that are specifically tailored to the individual purchaser or user based on the location and use information received from the purchaser or user of the item.

In one aspect of at least one embodiment of the present disclosure, the method for providing a uniquely trackable item that provide the retailer and affiliates various benefits and advantages. In another aspect of at least one embodiment of the present disclosure, the method for providing a device that identifies the unique identifier in the item and allows tracking of at least the location, use of or user of the item by one or more users. In yet another aspect of at least one embodiment of the present disclosure, where the uniquely trackable item has a unique identifier tag

FIG. 2 shows in accordance with at least one embodiment of the present disclosure, a method for providing the uniquely trackable items which provide additional revenue streams and benefits for retailers and affiliates. In another embodiment of the present disclosure, the method for providing an item containing a unique trackable identification tag where the item contains a unique trackable identification tag prior to entering the distribution channel. In yet another aspect of at least one embodiment of the present disclosure, receiving information from a retailer or affiliate regarding the item or one or more items associated with the item. In yet another aspect of at least one embodiment of the present disclosure providing the retailer or affiliate a percentage of the revenue generated from each sale of the item.

FIG. 3 shows in accordance with at least one embodiment of the present disclosure, a method for providing the uniquely trackable items which provide additional revenue streams and benefits for retailers and affiliates. In yet another embodiment of the present disclosure, the method for providing an item containing a unique trackable identification tag where the item contains a unique trackable identification tag prior to entering the distribution channel. In yet another aspect of at least one embodiment of the present disclosure, receiving information from a retailer or affiliate regarding the item or one or more items associated with the item. In yet another aspect of at least one embodiment of the present disclosure providing the retailer or affiliate various benefits and advantages from each sale of the item and its accessories.

FIG. 4 shows in accordance with at least one embodiment of the present disclosure, a method for providing the uniquely trackable items which provide additional revenue streams and benefits for retailers and affiliates. In another embodiment of the present disclosure, the method for providing an item containing a unique trackable identification tag where the item contains a unique trackable identification tag prior to entering the distribution channel. In yet another aspect of at least one embodiment of the present disclosure, the seller will receive additional award or incentive for selling the most number of the item or generating the most profit or revenue from the purchaser or user accepting offers or incentives that are specifically tailored to the individual purchaser or user based on the location and use information received from the purchaser or user of the item.

FIG. 5 shows in accordance with at least one embodiment of the present disclosure, a method for providing the uniquely trackable items which has a unique radio frequency identifier. In one embodiment of the present disclosure, the method for providing a uniquely trackable item for sale to one or more retailer or affiliates. In yet another aspect of at least one embodiment of the present disclosure, the method for providing a uniquely trackable item that provide the retailer and affiliates various benefits and advantages. In yet another aspect of at least one embodiment of the present disclosure, the method for providing a device that identifies the unique identifier in the item and allows tracking of at least the location, use of or user of the item by one or more users. In yet another aspect of at least one embodiment of the present disclosure, where the each uniquely trackable item has a unique identifier tag. In yet another aspect of at least one embodiment of the present disclosure, where the unique identifier of the trackable item is a radio frequency identifier.

FIG. 6 shows in accordance with at least one embodiment of the present disclosure, a method for providing the uniquely trackable items where the user registers the item online allowing the item to be tracked. In yet another embodiment of the present disclosure, the method for providing a uniquely trackable item for sale to one or more retailer or affiliates. In yet another aspect of at least one embodiment of the present disclosure, the method for providing a uniquely trackable item that provide the retailer and affiliates various benefits and advantages. In yet another aspect of at least one embodiment of the present disclosure, the method for providing a device that identifies the unique identifier in the item and allows tracking of at least the location, use of or user of the item by one or more users. In yet another aspect of at least one embodiment of the present disclosure, where the each uniquely trackable item has a unique identifier tag. In yet another aspect of at least one embodiment of the present disclosure, where the user registers the item online allowing the item to be tracked by the retailer or affiliate.

FIG. 7 shows in accordance with at least one embodiment of the present disclosure, a method for providing the uniquely trackable items where the uniquely trackable item can be tracked throughout its lifecycle. In yet another embodiment of the present disclosure, the method for providing a uniquely trackable item for sale to one or more retailer or affiliates. In yet another aspect of at least one embodiment of the present disclosure, the method for providing a uniquely trackable item that provide the retailer and affiliates various benefits and advantages. In yet another aspect of at least one embodiment of the present disclosure, the method for providing a device that identifies the unique identifier in the item and allows tracking of at least the location, use of or user of the item by one or more users. In yet another aspect of at least one embodiment of the present disclosure, where each uniquely trackable item has a unique identifier tag. In yet another aspect of at least one embodiment of the present disclosure, where the uniquely trackable item can be tracked throughout its lifecycle by the retailer or affiliate

FIG. 8 shows in accordance with at least one embodiment of the present disclosure, a method for providing the uniquely trackable items where the unique identifier of the item interacts with a computer, a mobile device or device having internet connectivity and provides information regarding at least the location, use of and user of the item by one or more users. In yet another embodiment of the present disclosure, the method for providing a uniquely trackable item for sale to one or more retailer or affiliates. In yet another aspect of at least one embodiment of the present disclosure, the method for providing a uniquely trackable item that provide the retailer and affiliates various benefits and advantages. In another aspect of at least one embodiment of the present disclosure, the method for providing a device that identifies the unique identifier in the item and allows tracking of at least the location, use of or user of the item by one or more users. In yet another aspect of at least one embodiment of the present disclosure, where each uniquely trackable item has a unique identifier tag. In yet another aspect of at least one embodiment of the present disclosure, where the unique identifier of the item interacts with a computer, a mobile device or device having internet connectivity such as mobile phone, smart phone and tablet computers, and provides information regarding at least the location, use of and user of the item by one or more users.

FIG. 9 shows in accordance with at least one embodiment of the present disclosure, a method for providing a uniquely trackable ID tagged item for sale to one or more retailer or affiliates which can be tracked in its entire life cycle allowing the retailer or affiliate to track at least the location, use of and user of the item. In yet another aspect of at least one embodiment of the present disclosure, the method for providing a uniquely trackable ID tagged item where the retailer or affiliate can offer sale of the related items to the users by tracking the item and based on the activity of the user with regards to the item. In yet another aspect of at least one embodiment of the present disclosure, the retailer or affiliate can provide customized offers and marketing strategies to each user based on at least the location, use and user of the item.

In yet another embodiment of the present disclosure, each user is provided with a unique ID card. The unique ID card stores the information and data about the items and related items already purchased by the user without the user having to physically carry all the items. The user can log into his account using the unique ID card and view his collection of items. In yet another aspect of at least one embodiment of the present disclosure, if the user goes to any retail store to buy the item or related items, the user can use the unique ID card which recognizes the items the user has already purchased and can buy related items and accessories accordingly.

In yet another embodiment of the present disclosure, the method for providing a uniquely trackable ID tagged item to a user by the retailer or affiliate which provides additional revenue streams and benefits for retailers or affiliates. In yet another aspect of at least one embodiment the uniquely trackable items are ID tagged by the provider before they are sent out to the retailer or affiliate through the distribution channel. In yet another aspect of at least one embodiment the present disclosure shows the method for providing a uniquely trackable ID tagged item for sale to one or more retailer or affiliates which can be tracked in its entire life cycle allowing the retailer or affiliate to track at least the location, use of and user of the item

In yet another embodiment of the present disclosure, the provider of the item provides the uniquely ID tagged item to the retailers or affiliates. In yet another aspect of at least one embodiment, each time the retailer or affiliate makes a sale of the uniquely trackable ID tagged item they benefit and get advantage from the sale. In yet another aspect of at least one embodiment of the present disclosure, a method for providing a uniquely trackable ID tagged item to a user which provides monetary gain and other benefits to retailers and affiliates. In yet another aspect of at least one embodiment of the present disclosure, each time the retailer or affiliate makes a sale of the uniquely trackable ID tagged item they get a percentage of the revenue generated from the sale thus motivating and encouraging the retailer or affiliate to promote the sale of the uniquely trackable ID tagged items over other products. In yet another aspect of at least one embodiment of the present disclosure, the retailer also obtains a percentage of the revenue generated each time the consumer buys additional related products or accessories for the uniquely trackable ID tagged item. In yet another aspect of at least one embodiment of the present disclosure the retailer or affiliate also benefits and gets advantage each time the consumer buys additional items or accessories associated with the uniquely trackable ID tagged item. yet another aspect of at least one embodiment of the present disclosure, the retailer or affiliate with better sales performance is provided with a higher share of the revenue generated. In yet another aspect of at least one embodiment, the method of the present disclosure motivates and encourages the retailer or affiliate to promote the sale of the uniquely trackable ID tagged items over other products in the store.

In yet another embodiment of the present disclosure, the method for providing a uniquely trackable ID tagged item where if the user is in the store to buy the uniquely trackable ID tagged item and ends up buying other unrelated items from the store, the retailer or affiliate provide a percentage share of the revenue generated back to the provider of the uniquely trackable ID tagged item.

What is claimed is:

1. A method comprising:
providing an item containing a unique identifier to seller of the item, wherein the unique identifier identifies at least the location and purchaser or user of the item;
receiving information about at least the location and use of the item from the purchaser or user of the item;
providing the purchaser or user of the item with one or more offers or incentives that are specifically tailored to the individual purchaser or user based on the location and use information received from the purchaser or user of the item; and
providing the seller with a monetary incentive or reward whenever the seller sells the item or the purchaser or user accepts one or more offers or incentives that are specifically tailored to the individual purchaser or user based on the location and use information received from the purchaser or user of the item.

2. The method of claim 1, wherein the monetary incentive or reward is a percentage of revenue generated from the sale of the item.

3. The method of claim 1, further providing:
providing the seller monetary incentive or reward when the purchaser buys one or more accessories related to the item.

4. The method of claim 1, wherein the information about at least the location and use of the item from the purchaser or user of the item is transmitted from the purchaser or user through computer, a mobile device or device having internet connectivity.

5. The method of claim 4, wherein the seller uses the information to modify the design, distribution channel, or location of the item.

6. The method of claim 1, wherein the seller will receive additional award or incentive for selling the most number of the item or generating the most profit or revenue from the purchaser or user accepting offers or incentives that are specifically tailored to the individual purchaser or user based on the location and use information received from the purchaser or user of the item.

7. The method of claim 1, wherein the offers or incentives is the ability to participate in an interactive on-line community that incorporates a digital version of the item.

8. The method of claim 1, wherein the unique identifier is a bar code or radio frequency identifier.

9. The method of claim 1, wherein the purchaser or user of the item can register the item online allowing the receive promotions from the seller of the item.

10. A method comprising:
providing an item containing a unique identifier to seller of the item, wherein the unique identifier identifies at least the location and purchaser or user of the item;
receiving information about at least the location and use of the item from the purchaser or user of the item through computer, mobile device or device having internet connectivity;
providing the purchaser or user of the item with one or more offers or incentives that are tailored to the individual purchaser or user based on the location and use information received from the purchaser or user of the item; and
providing the seller with a monetary incentive or reward whenever the seller sells the item or the purchaser or user accepts one or more offers or incentives that are tailored to the individual purchaser or user based on the location and use information received from the purchaser or user of the item.

11. The method of claim 10, wherein the offer is special download of software.

12. The method of claim 10, wherein the seller will receive additional monetary incentive or reward when the purchaser buys related accessories of the item.

13. The method of claim 10, wherein the seller will receive additional award or incentive for selling the most number of the item or generating the most profit or revenue from the purchaser or user accepting offers or incentives that are specifically tailored to the individual purchaser or user based on the location and use information received from the purchaser or user of the item.

14. The method of claim 10, wherein the seller uses information to modify design of the item or distribution channel, location or strategy.

15. The method of claim 10, wherein the mobile device include mobile phone, smart phone and tablet computers.

16. A method comprising:
providing an item containing a unique identifier to seller of the item, wherein the unique identifier identifies at least the location and purchaser or user of the item;
receiving information about at least the location and use of the item when the purchaser or user of the item registered the item through computer, mobile device or device having internet connectivity;
providing the purchaser or user of the item with one or more offers or incentives that are tailored to the individual purchaser or user based on the location and use information received from the purchaser or user of the item during lifecycle of the item; and
providing the seller with a monetary incentive or reward whenever the seller sells the item or each time the purchaser buys accessories or items related to the item.

17. The method of claim 16, wherein when the item is registered, a digital version of the item is provided to the purchaser.

18. The method of claim 17, wherein the item will interact or associate with digital version of the item.

19. The method of claim 16, wherein the purchaser can purchase digital version of the item before receiving the actual item.

20. The method of claim 16, wherein the item is tracked throughout its lifecycle.
